(19) United States
(12) Patent Application Publication
(10) Pub. No.: US 2025/0155189 A1
(43) Pub. Date: May 15, 2025

(54) REFRIGERATOR AND CONTROL METHOD THEREFOR

(71) Applicant: SAMSUNG ELECTRONICS CO., LTD., Suwon-si (KR)

(72) Inventors: Saeeap KIM, Suwon-si (KR); Ganghyun KIM, Suwon-si (KR); Myungjong KIM, Suwon-si (KR)

(73) Assignee: SAMSUNG ELECTRONICS CO., LTD., Suwon-si (KR)

(21) Appl. No.: 19/022,650

(22) Filed: Jan. 15, 2025

Related U.S. Application Data
(63) Continuation of application No. PCT/KR2023/014157, filed on Sep. 19, 2023.

(30) Foreign Application Priority Data
Oct. 17, 2022 (KR) 10-2022-0133252

(51) Int. Cl. F25D 23/02; F25D 29/00

(52) U.S. Cl. CPC F25D 23/028; F25D 29/005; F25D 2400/361; F25D 2700/06

(57) ABSTRACT

A refrigerator including a main body having a storage chamber, a door which is rotatable while coupled to the main body so as to open/close the storage chamber; a door opening device, which includes a motor to drive a protrusion member, to open the door through a rotation of the motor, a memory to store door opening angle information of the door; and a processor to control the door opening device based the stored door opening angle information upon an event in which the door be opened occurs. The processor controls the motor such that the protrusion member protrudes toward a protrusion position corresponding to the stored door opening angle information among a plurality of protrusion positions.

### CROSS-REFERENCE TO RELATED APPLICATION

This application is a continuation application is a continuation application, under 35 U.S.C. § 111(a), of international application No. PCT/KR2023/014157, filed Sep. 19, 2023, which claims priority under 35 U. S. C. § 119 to Korean Patent Application No. 10-2022-0133252, filed 17 Oct. 2022, the disclosures of which are incorporated herein by reference in their entireties.

### TECHNICAL FIELD

The disclosure relates to a refrigerator and a control method therefor and more particularly, to a refrigerator automatically opening a door according to a door opening speed and/or a door opening angle set by a user and a control method therefor.

### BACKGROUND ART

In general, a refrigerator is a home appliance that includes a storage chamber which stores food and a cool air providing device which provides cool air to the storage chamber to keep the food fresh for a long time.

The refrigerator includes a door for opening the storage chamber. A recent refrigerator provides a function of automatically opening a door without an action that a user directly pulls the door, etc.

### DISCLOSURE

### Technical Solution

To achieve the purpose as above, a refrigerator according to an embodiment of the disclosure includes a main body having a storage chamber, a door which is rotatable while coupled to the main body to open and close the storage chamber, a door opening device, which includes a motor to drive a protrusion member, to open the door through a rotation of the motor, a memory to store door opening angle information of the door, and a processor to control the door opening device based on the stored door opening angle information upon an event in which the door be open occurs.

In this case, the processor may control the door opening device to open the door by controlling the rotation of the motor to drive the protrusion member so that the protrusion member protrudes toward a protrusion position corresponding to the stored door opening angle information among a plurality of protrusion positions.

Meanwhile, according to an embodiment of the disclosure, a method for controlling a refrigerator including a door opening device comprises storing door opening angle information of the door, the door opening device including a motor to drive a protrusion member. The method including confirming occurrence of an event that the door be open occurs, and based on the event occurring, controlling the door opening device to open the door by controlling a rotation of the motor such that the protrusion member protrudes toward a protrusion position corresponding to the stored door opening angle information among a plurality of protrusion positions.

### DESCRIPTION OF DRAWINGS

The aforementioned aspects or the other aspects, features, advantages of embodiments of the disclosure may be more clarified based on the description below with reference to the appended drawings. In the appended drawings:

FIG. 1 is a perspective view illustrating a refrigerator according to an embodiment;

FIG. 2 is an enlarged perspective view illustrating a refrigerator which opens a second door according to an embodiment;

FIG. 3 is a view illustrating a shape of a door opening device of FIG. 2 according to an embodiment;

FIG. 4 is a view illustrating a configuration of a refrigerator according to an embodiment;

FIG. 5 is a view illustrating a configuration of a refrigerator according to an embodiment;

FIG. 6 is a view illustrating an operation of a display according to an embodiment;

FIG. 7 is a view illustrating an operation of receiving a setting of a door opening speed or a door opening angle through a user interface window according to an embodiment;

FIG. 8 is a view illustrating a relation of a defined door opening speed and door opening angle, and an operation of a motor and a relation among operations of a protrusion member according to an embodiment;

FIG. 9 is a view illustrating a door opening operation of a refrigerator according to an embodiment; and

FIG. 10 is a flow chart illustrating a method of controlling a refrigerator according to an embodiment.

### MODE FOR INVENTION

Various embodiments of the disclosure and the terms used therein are not intended to limit technical features described in the disclosure to a specific embodiment, wherein such embodiments should be interpreted to include various modifications, equivalents, or substitutes of the relevant embodiment.

With respect to the description of the drawings, a similar or related component may be designated by a similar reference numeral.

A singular form of a noun corresponding to an item may be construed as including one item or a plurality of items unless explicitly differently indicated in the related context.

In the disclosure, each of the phrases such as “A or B”, “at least one of A and B”, “at least one of A or B”, ‘A, B, or C”, “at least one of A, B, and C”, and “at least one of A, B, or C” may be construed as including any one of items enumerated together with the relevant phrase among the phrases or all possible combinations thereof.

The term “and/or” is construed as including a combination of a plurality of related and described components or any component of the plurality of related and described components.

The term such as “1st”, “2nd”, “first”, or “second” may be used to simply distinguish one component from another component and is not intended to limit the relevant component in regard of a different aspect (e.g. importance or an order).

The description that one (e.g. a first) component is “coupled with/to” or “connected to” another (e.g. a second) component “operatively” or “communicatively” or without the relevant term should be interpreted such that the one component may be connected to the another component directly (e.g. wiredly), wirelessly, or through a third component.

The term “include”, “have”, or the like should be construed as designating that there is a characteristic, a number, a step, an operation, a component, a part, or a combination thereof described in the disclosure but not as excluding in advance possibility of the existence or addition of one or more other characteristics, numbers, steps, operations, components, parts, or a combination thereof.

When it is described that one component “is connected to”, “is coupled to”, “is supported by”, or “contacts” another component, the description includes not only a case that the component is connected to, is coupled to, is supported by, or contacts the another component directly but also a case that the component is connected to, is coupled to, is supported by, or contacts the another component indirectly through a third component.

When it is described that one component is positioned “on” another component, the description includes not only a case that the component contacts the another component but also a case that the other component is present between two components.

The terms used in embodiments of the disclosure may be interpreted as meanings generally known to those skilled in the art unless defined otherwise.

Also, the term ‘front end’, ‘rear end’, ‘upper part, ‘lower part’, ‘upper end’, ‘lower end’, or the like is not defined based on the drawings and a shape and a position of each component is not limited by the relevant term.

Hereinafter, with reference to the appended drawings, a refrigerator according to various embodiments is specifically described.

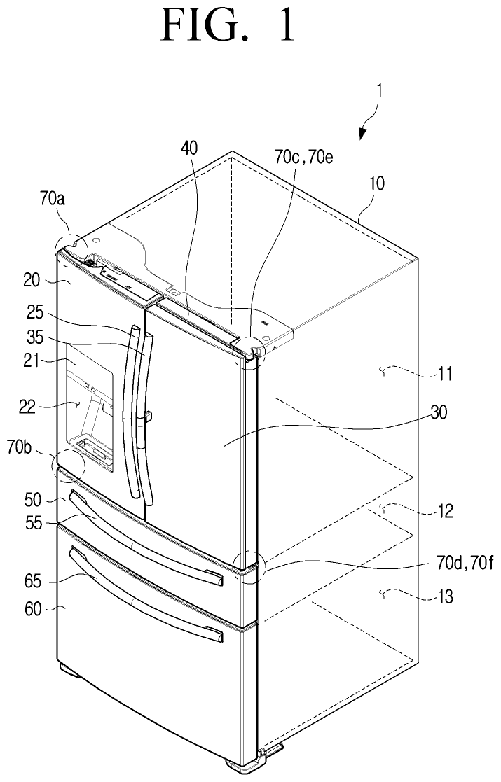

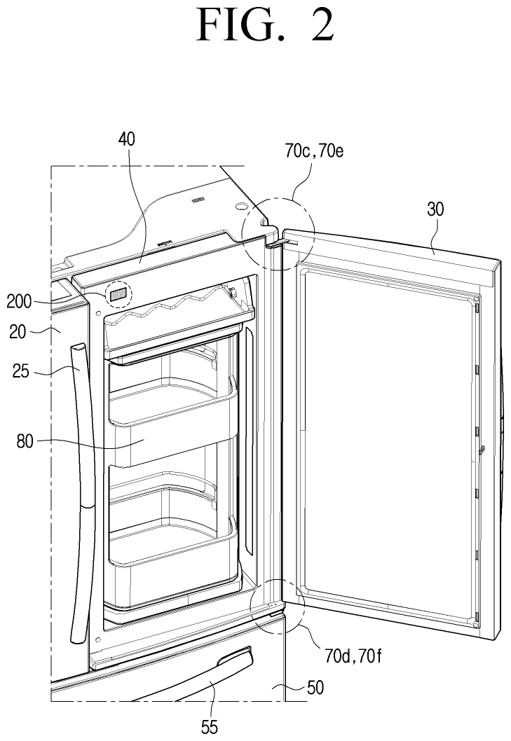

FIG. 1 is a perspective view illustrating a refrigerator 1 according to an embodiment. FIG. 2 is an enlarged perspective view illustrating a refrigerator which opens a second door 30.

With reference to FIGS. 1 to 2, the refrigerator 1 may include a main body 10, a door 20, 30, 40, a drawer 50, 60 including a handle 55. 65, and a hinge 70 (70a-70f).

The refrigerator 1 may be a device for storing food or medicine at a preset temperature to cool or not to decay the food or medicine. The refrigerator 1 is shown as a shape of a general home refrigerator but is not limited thereto and may be a Kimchi refrigerator, a liquor refrigerator, a cosmetics refrigerator, a freezer, etc.

The main body 10 may have an approximately cuboid shape of which a front surface is opened but is not limited thereto, wherein a size and a shape thereof may be variously formed.

It is shown in FIG. 1 that the refrigerator 1 includes a door 20, 30 at both sides of an upper part and a lower part thereof includes a drawer 50, 60 but the disclosure is not limited thereto, wherein the refrigerator 1 may be in a French Door Type, a Side-by-side Type, or the like depending on an arrangement of the door 20, 30, the drawer 50, 60, and a storage chamber 11, 12, 13.

The main body 10 may include the storage chamber 11, 12, 13 which is opened by the openable and closeable door 20, 30, 40 and stores water, beverage, chilled food, or frozen food.

The main body 10 may include an inner case (not shown) forming the storage chamber 11, 12, 13, an outer case (not shown) forming an appearance of the refrigerator, and an insulator (not shown) maintaining a difference in temperatures between the inner case and the outer case.

The insulator may prevent cool air inside the storage chamber 11, 12, 13 from leaking into the outside and prevent external warmth from flowing into the inside of the storage chamber 11, 12, 13.

The storage chamber 11, 12, 13 may be comparted by a partition disposed inside the main body 10. The storage chamber 11, 12, 13 may be divided into a freezing chamber 12, 13 disposed on the lower part of the refrigerator 1 and a refrigerating chamber 11 disposed on the upper part thereof. However, an arrangement of the freezing chamber 12, 13 and the refrigerating chamber 11 is not limited thereto and the arrangement may be made such that their positions are switched.

The first door 20 may rotate at an angle (e.g. 300° or less) defined by a hinge 70a, 70b and may open and close part of a front surface of the storage chamber 11.

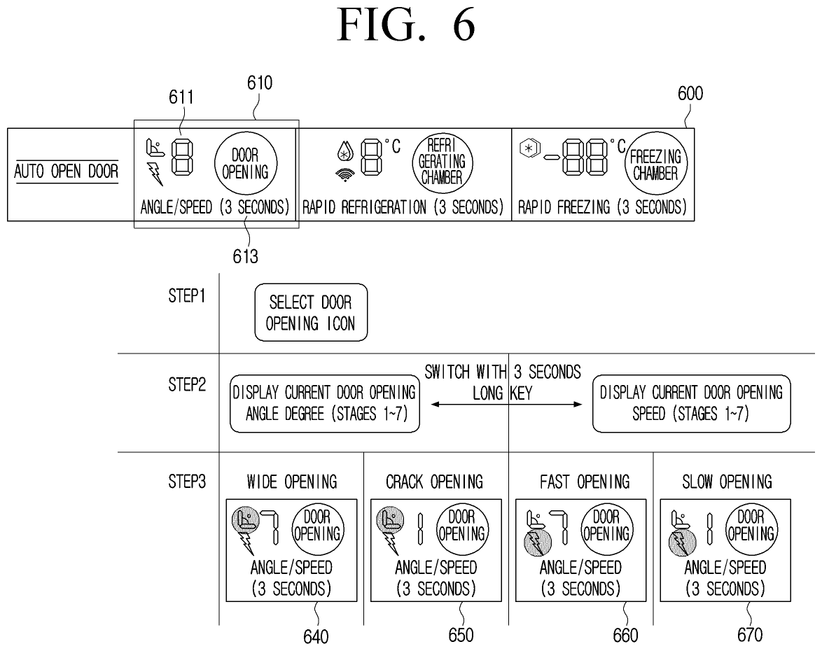

The first door 20 may include a manipulation panel 21 capable of displaying a function and a setting of the refrigerator 1 on its surface and being changed by a user input (e.g. a touch or selection of a button), a dispenser 22 providing water, ice, or sparkling water, and/or a knob 25 capable of being gripped. Through this manipulation panel 21, a user may input not only a storage temperature of the refrigerator but also a command of opening a door and may define a door opening speed and/or a door opening angle of the door. A detailed content of the manipulation panel 21 is after-mentioned with reference to FIG. 6.

The second door (or an outer door, 30) and/or the third door (or an inner door, 40) may rotate at an angle (e.g. 300° or less) defined by the hinges 70c to 70f to open and close part of the front surface of the storage chamber 111.

The second door 30 may include a knob (handle) 35 capable of being gripped. The knob 25 of the first door 20 and the knob 35 of the second door 30 may be positioned to be spaced apart from each other in a criterion of a center area of the storage chamber 111.

The second door 30 and the third door 40 which open and close part of the first storage chamber 11 may be prepared as a double door. However, the disclosure is not limited thereto and the first door 20 may be prepared as a double door.

The second door 30 may be relatively rotatably coupled to the third door 40. That is, the second door 30 may be opened or closed independently from the third door 40 and may be opened or closed together with the third door 40. Here, the second door 30 may be opened by a door opening device 200 to be after-mentioned.

The third door 40 may include an opening corresponding to part of the first storage chamber 11. The opening of the third door 40 may be opened or closed by the second door 30.

If the second door 30 is opened by the user or the door opening device 200, a door guard 80 prepared on the opening of the third door 131 may be exposed to the outside. The door guard 80 may include a plurality of shelves which may store food and may be detachably coupled to the third door 40.

The user may easily access to food or the like stored in the door guard 80 by opening only the second door 30. Also, in the case of opening only the second door 30, a leak of cool air of the refrigerator 1 to the outside may be reduced compared to the case of opening the second door 30 and the third door 40 together.

As above, the second door 30 and the third door 40 are doubly disposed and each of them is configured to rotate relatively and thus the user may store and take out food in various methods depending on the user's need and may reduce the leak of cool air.

The door opening device 200 may be disposed on the third door 40 and if a door opening event occurs, may open the second door 30. To open the second door 30, the door opening device 200 may be disposed at a position spaced apart from the hinge 70a, 70b which connects the second door 30 and the third door 40.

Further, the door opening device 200 may be disposed on an area of an upper end of the third door 40. Specifically, because a protrusion member of the door opening device 200 protrudes to open the third door 40, it is more favorable for the user to use the door guard 80 that the door opening device is disposed on the area of the upper end. However, upon implementing, the door opening device may be disposed on a side surface of the third door 40 and may be also disposed on an area of a lower end.

Also, it is illustrated in a shown example that only one door opening device 200 is disposed on the third door 40 but upon implementing, it may be implemented in a form that the door opening device 200 is disposed at each of the upper end and the lower end of the third door 40.

Also, in illustrating FIGS. 1 and 2, it is shown that the door opening device 200 opens only the second door 30 but the door opening device 200 may open the first door 20 or the third door 40. In this case, the door opening device 200 may be disposed at a specific area of the main body 10 for opening each door.

Also, upon implementing, the refrigerator 1 may open a plurality of doors at the same time correspondingly to a door opening event. Specifically, a plurality of door opening devices may be disposed on a plurality of areas of the main body 10 corresponding to the first door 20 and the third door 40 and may open the first door 20 and the third door 40 together correspondingly to the door opening event.

Also, upon implementing, the door opening device may be disposed on every door and may selectively open a door corresponding to a request in response to the user's request (or a user command). As above, in case that various door opening is possible, a door corresponding to a user voice command may be opened in response to the user voice command. For example, if the first door 20 is a door which opens and closes a freezing chamber and the third door 40 is a door which opens and closes a refrigerating chamber, a door opening device corresponding to the first door 20 operates correspondingly to an opening and closing event of the freezing chamber to open and close the first door 20. Otherwise, the third door 40 may be opened or closed correspondingly to an opening and closing event of the refrigerating chamber.

If a door opening command (or a door opening event) occurs without separately designating a door, only a preset door (e.g. the third door 40) may be opened. For example, if the third door 40 is a door which opens and closes a refrigerating chamber, only the third door 40 may be opened or closed correspondingly to a door opening and closing command.

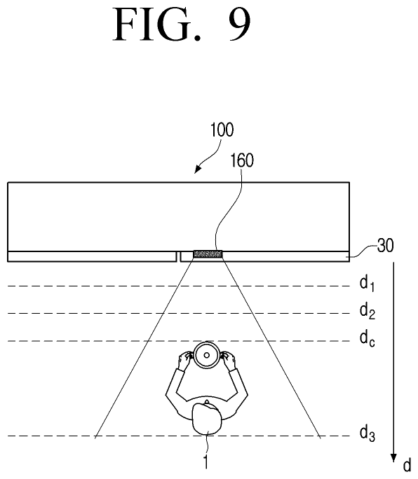

Meanwhile, the door opening event for opening the door may occur in various methods. In advance, if the user is positioned around the refrigerator, the door opening event may occur. Operations as above are described in FIG. 9. Further, if the user inputs the door opening command through a voice command, the door opening event may occur. Also, if the user inputs the door opening command into an external device such as a manipulation panel of the refrigerator 1, a smart phone, or the like, the door opening event may occur.

Meanwhile, in illustrating and describing FIGS. 1 and 2, it is described that only with respect to a rotatable door, the relevant door is automatically opened. However, upon implementing, the door opening device may be disposed with respect to not only the storage chamber but also the drawer 50, 60 openable in a rotating method to automatically open the relevant drawer.

As above, the refrigerator 1 according to the disclosure may automatically open a door by using the door opening device 200 and thus the user may easily open and use the desired storage chamber.

Meanwhile, the refrigerator may be used under various circumstances. For example, the refrigerator may be disposed under a circumstance that a door of the refrigerator cannot be opened wide. Under this circumstance, if the door is opened at a door opening angle defined by a manufacturer, there is possibility that an impact is applied to the door. Also, if the refrigerator is disposed in a house where there is a child and the door is rapidly opened, there is possibility that the child is injured. On the contrary, in case of only an adult uses the refrigerator, if the door is opened slow to prevent a crash on the door, the user may feel stuffy due to a door opening speed.

Therefore, there is a need for a method that the user may change and use an opening speed and an opening angle of the door in consideration of various installation environments, the user, etc. Hereinafter, is described a method capable of changing a door opening angle and/or a door opening speed of a refrigerator having a function of automatic door opening.

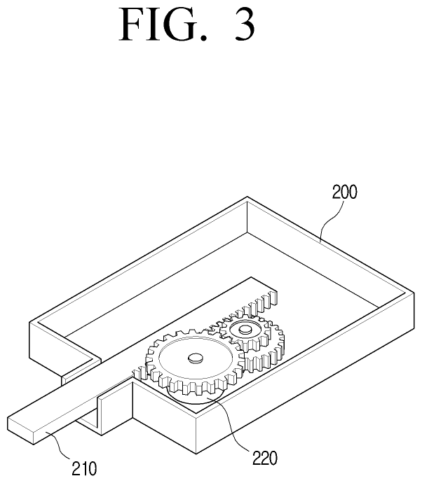

FIG. 3 is a view illustrating a shape of a door opening device of FIG. 2.

With reference to FIG. 3, the door opening device 200 may include a protrusion member (or a protrusion bar) 210 and a motor 220.

The protrusion member 210 may have a long bar shape. The protrusion member 210 as above may be generally stored in the door opening device 200 and may protrude toward a preset protrusion position according to a drive of the motor 220. The protrusion position as above may be distinguished by a plurality of intervals between a maximum protrusion position to which the protrusion member may protrude and a minimum protrusion position for opening the door. The intervals as above may be uniformed and may not be uniformed. For example, if the user may select one of seven degrees of protrusion, the protrusion position may be divided into seven.

Further, the protrusion member 210 may have not only a bar shape but also a foldable or telescopic (or multilevel) shape. For example, if the protrusion member is implemented in a foldable or telescopic method, it is possible to protrude in a longer length than a size of a built-in space.

The motor 220 drives the protrusion member. Specifically, the door opening device 200 may further include various gear members and may provide a rotational force to the relevant gear member and thus, the protrusion member 210 may protrude to the preset position or may be stored in the door opening device 200.

Also, the motor 220 may perform rotation at a speed corresponding to a preset door opening speed. For example, the motor may rotate at a low speed with respect to a relatively slow door opening speed and may rotate at a high speed with respect to a relatively fast door opening speed. Accordingly, the protrusion member may protrude at a speed corresponding to a rotation speed of the motor 220.

As above, if the motor 220 is driven to rotate various gears, the protrusion member 210 connected to the gears starts to protrude. Accordingly, an end of the protrusion member 210 touches a door of the refrigerator and as the protrusion member 210 continuously protrudes in a touched state, the door of the refrigerator is opened.

Hereinafter, is described a method for controlling a door opening angle and a door opening speed of the door through the aforementioned configuration.

In advance, the door opening angle is described. To facilitate the description, the description is made under the assumption that a movement speed of the motor (or the protrusion member) is the same.

The door opening angle may be adjusted according to a protrusion degree of the protrusion member 210. Specifically, the protrusion member 210 moves with touching the door and in this regard, the door opening angle is determined to correspond to a final protrusion position of the protrusion member 210. For example, if the protrusion member 210 protrudes relatively short, the door is opened at a small angle. On the contrary, if the protrusion member 210 protrudes relatively long, the door is opened at a larger angle.

Meanwhile, the door opening angle may be affected by not only the protrusion angle but also the movement speed of the protrusion member. For example, if the protrusion member moves at a slow movement speed, the door is opened only at an angle corresponding to the maximum protrusion position of the protrusion member. However, if the protrusion member moves at a fast movement speed, a force applied to the door increases and the door has a larger opening angle by a transmitted force (or a rotational force) even in a state that the protrusion member does not touch the door any more.

As above, the door opening angle is affected by not only a protrusion degree (or a protrusion length) of the protrusion member but also a movement speed of the protrusion member.

On the contrary, even though the door is opened at the same angle, various protrusion degrees and movement speeds may be used. For example, in both of a case that a low movement speed and a high protrusion degree are used and a case that a high movement speed and a low protrusion degree are used, it is possible to open the door at the same rotation angle.

In the disclosure, by using this point, an opening time and an opening angle according to various protrusion degrees and various protrusion speeds may be confirmed through an experiment, lookup data may be generated and used based on an experimental result, or a calculation formula may be generated and used.

Accordingly, if the user defines the opening time and the opening angle, the motor may be controlled such that the protrusion member protrudes at a speed and in a protrusion degree corresponding to the defined opening time or opening angle.

Meanwhile, upon implementing, it is also possible to store and use information about a driving speed of the motor and a driving time of the motor rather than the speed and the protrusion degree corresponding to the defined opening time or opening angle.

As above, the door opening device according to the disclosure may move the protrusion member at various protrusion angles and protrusion speeds and thus it is possible to open the door correspondingly to various door opening speeds and door opening angles of the user.

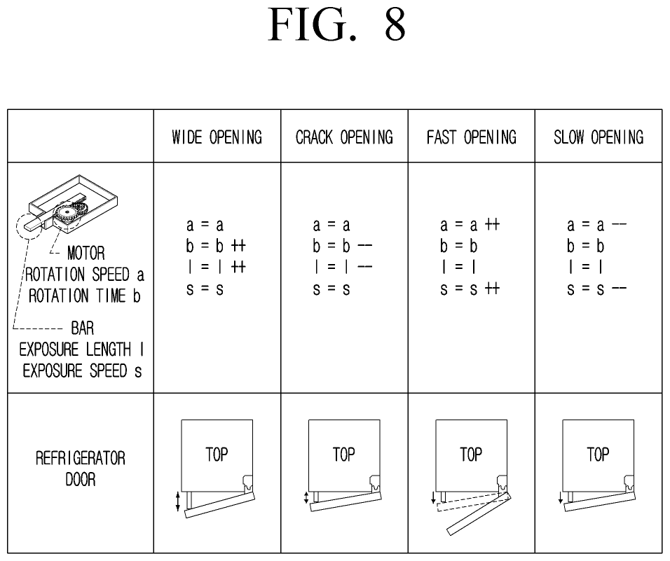

Meanwhile, in illustrating and describing FIG. 3, it is described that the user defines all of the door opening speed and the door opening angle but upon implementing, it is also possible to define only the door opening speed or define only the door opening angle. That is, the door opening speed may be implemented in a form of maintaining the door opening speed identically and adjusting only the door opening angle or in a form of adjusting only the door opening angle regardless of the door opening speed. Otherwise, the door opening angle may be also implemented in a form of maintaining the door opening angle identically and adjusting only the door opening speed. An example as above is after-mentioned with reference to FIG. 8.

Meanwhile, in illustrating and describing FIG. 3, it is described that the door opening device 200 opens the door of the refrigerator but upon implementing, the door opening device 200 may be also applied with respect to other electronic devices besides the refrigerator. For example, operations of the disclosure may be applied to any electronic device including a rotatably disposed door such as a washing machine, a microwave oven, an oven, or the like besides the refrigerator.

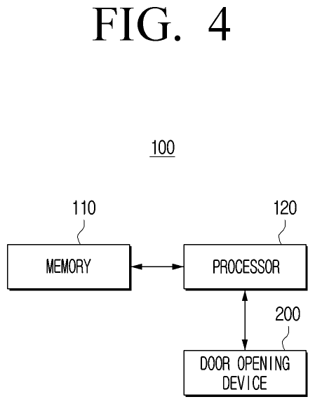

FIG. 4 is a view illustrating a configuration of a refrigerator according to an embodiment. Specifically, FIG. 4 is a view illustrating only a simple configuration of the refrigerator according to an embodiment of the disclosure.

With reference to FIG. 4, a refrigerator 100 includes memory 110, a processor 120, and a door opening device 200. A specific configuration and operation of the door opening device 200 is previously described in FIG. 3 and thus, hereinafter, the memory 110 and the processor 120 are described.

The memory 110 is a component for storing an O/S for driving the refrigerator 100, various software, data, or the like. The memory 110 may be implemented in various forms such as RAM or ROM, flash memory, a HDD, external memory, and a memory card, wherein it is not limited to any one of the above. Further, the memory 110 may include one memory chip or two or more memory chips or may include one memory block or two or more memory blocks.

The memory 110 may store various setting values. For example, various setting values may be setting temperature information, door opening angle information, door opening speed information, or the like.

Here, the setting temperature information may be a temperature value defined with respect to a maintenance temperature in a storage chamber included in the refrigerator 100.

Further, the door opening angle information is door opening angle information defined by a user, for example, it is a numeral value (e.g. any one value of 1 to 7) directly selected by the user or motor driving information corresponding to the numeral value selected by the user (e.g. a driving speed and a driving time with respect to a motor performing a door opening operation).

Further, the door opening speed information is door opening speed information defined by the user, for example, it may be a numeral value directly selected by the user or motor driving information corresponding to the numeral value selected by the user.

The memory 110 may store a lookup table having information about the driving speed and the driving time of the motor corresponding to a plurality of numeral values corresponding to each of the door opening speed and the door opening angle.

The processor 120 controls the refrigerator 100. The processor 120 as above may be implemented as one chip performing the aforementioned function of the memory 110 together and may be also implemented as a separate additional chip.

Further, the processor 120 may be implemented as a digital signal processor (DSP) processing a digital signal, a microprocessor, or a time controller (TCON). Meanwhile, the disclosure is not limited thereto and it may include one or more of a central processing unit (CPU), a micro controller unit (MCU), a micro processing unit (MPU), a controller, an application processor (AP), a graphics-processing unit (GPU) or a communication processor (CP), and an ARM processor or may be defined based on the relevant terms. Also, the processor 120 may be implemented as a system on chip (SoC) in which processing algorithm is embedded or a large scale integration (LSI) and may be implemented in a form of a field programmable gate array (FPGA).

Further, the processor 120 may perform a basic function of the refrigerator 100. Specifically, the processor 120 may control a cooling device (not shown) such that each storage chamber of the refrigerator 100 maintains a temperature value corresponding to that of each storage chamber.

Further, the processor 120, if a door opening event occurs, may control the door opening device 200 to perform door opening based on the stored door opening angle information. Specifically, the processor 120 may control the door opening device 200 such that the protrusion member protrudes toward a protrusion position corresponding to the prestored door opening angle information among a plurality of protrusion positions.

Also, the processor 120, if the door opening event occurs, may control the door opening device 200 to perform door opening based on the stored door opening speed information. Specifically, the processor 120 may control the motor to rotate at a driving speed corresponding to the door opening speed among a plurality of driving speeds.

Also, the processor 120, if the door opening event occurs, may control the door opening device 200 to perform door opening in consideration of both of the aforementioned two information. Specifically, the processor 120 may determine a driving speed and a driving time corresponding to the stored door opening speed and door opening angle information and may control the door opening device 200 to operate at the determined driving speed and driving time. Here, the processor 120 may determine the driving speed and the driving time corresponding to the door opening speed and door opening angle information defined by using the lookup table. Otherwise, the processor may determine a driving speed and a driving time corresponding to the door opening speed and door opening angle information by using a calculation formula provided by a manufacturer.

Meanwhile, upon implementing, the driving speed and the driving time may not be determined at a time point when the door opening event occurs but may be determined before occurrence of the event. For example, at a time point when the user defines the door opening speed and the door opening angle, the user may determine the driving speed and the driving time corresponding to the relevant opening speed and door opening angle information and store the determined information, thereby using the predetermined driving speed and driving time as they are at a time point when the event occurs.

In this case, the processor 120 may not provide information about the prestored driving speed and driving time to the door opening device 200 at the time point when the event occurs but may be implemented in a form of generating and providing a motor control signal corresponding to the driving speed and the driving time to the door opening device 200.

Also, in case that the door opening device 200 includes a separate control unit, or the like, information about the driving speed and the driving time may be stored in a control unit of the door opening device 200. In this case, the processor 120 may merely notify the door opening device 200 that the door opening event occurs and the door opening device 200 may perform an operation corresponding to the prestored driving speed and driving time.

As above, the refrigerator 100 according to the disclosure may automatically open the door correspondingly to the door opening speed and/or the door opening angle defined by the user and thus may perform an operation corresponding to various user needs.

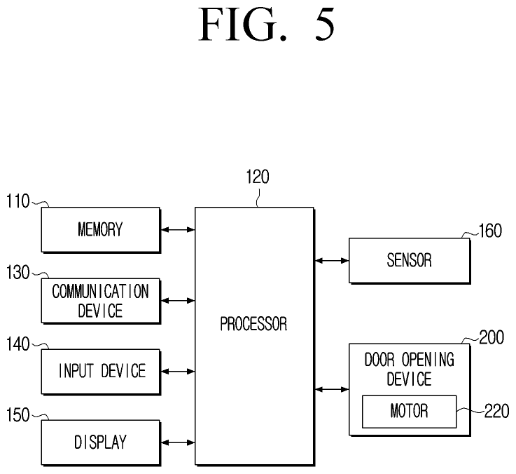

Meanwhile, in FIG. 4, only a simple configuration of the refrigerator 100 is shown but the refrigerator 100 may further include various configurations which are not shown in FIG. 4. With respect to the above, the description is made with reference to FIG. 5.

FIG. 5 is a view illustrating a configuration of a refrigerator according to an embodiment.

With reference to FIG. 5, the refrigerator 100 may include memory 110, a processor 120, a communication device 130, an input device 140, a display 150, a door opening device 200, and a sensor 160.

The configuration of the memory 110 and the processor 120 is previously described in FIG. 4 and thus only an additional function related to an additional configuration is described.

The communication device 130 may include at least one circuit and perform communication with various types of external devices. The communication device 130 may include a wireless communication module. As an example, the communication device 130 may include at least one of a Wi-Fi module, a Bluetooth communication module, a cellular communication module, a 4th generation Long Term Evolution (LTE) communication module, or a 5G communication module.

The communication device 130 may receive a user command for opening a door transmitted from the user terminal device. Also, the communication device 130, if the user voice command is obtained through the input device 140, may transmit the obtained voice command to the external sever. Here, the processor 120 may receive a signal for performing an operation corresponding to the user voice command from the external server and control the door opening device 200 based on the received signal. Meanwhile, the above is merely an example, wherein the processor 120 may control the door opening device 200 by recognizing the user voice command obtained through the input device 140.

The communication device 130 may receive setting information. Here, the setting information is a setting value related to each function of the refrigerator and may include information such as a setting temperature with respect to a refrigerating chamber, a setting temperature with respect to a freezing chamber, a door opening speed, and a door opening angle, etc. Also, if the refrigerator 100 may open a plurality of doors, it may receive information about a door to perform a basic door opening as setting information.

The input device 140 may provide an electric output signal corresponding to the user input to the processor 120. The input device may include, for example, a button capable of changing a setting temperature of the refrigerating chamber or the freezing chamber, and a button for adjusting a door opening speed or a door opening angle. This button may be configured of, for example, a tact switch, a push switch, a slide switch, a toggle switch, a micro switch, or a touch switch.

The display 150 may receive a signal from the processor 120 and display information corresponding to the received signal. The display 150 may include a screen displaying a temperature defined with respect to each storage chamber, a screen displaying a defined door opening speed or a defined door opening angle, etc. The display 150 may include, for example, a Liquid Crystal Display (LCD) panel, or a Light Emitting Diode (LED) panel.

The input device 140 and the display 150 may be implemented as a touch screen which may perform input and display operations together.

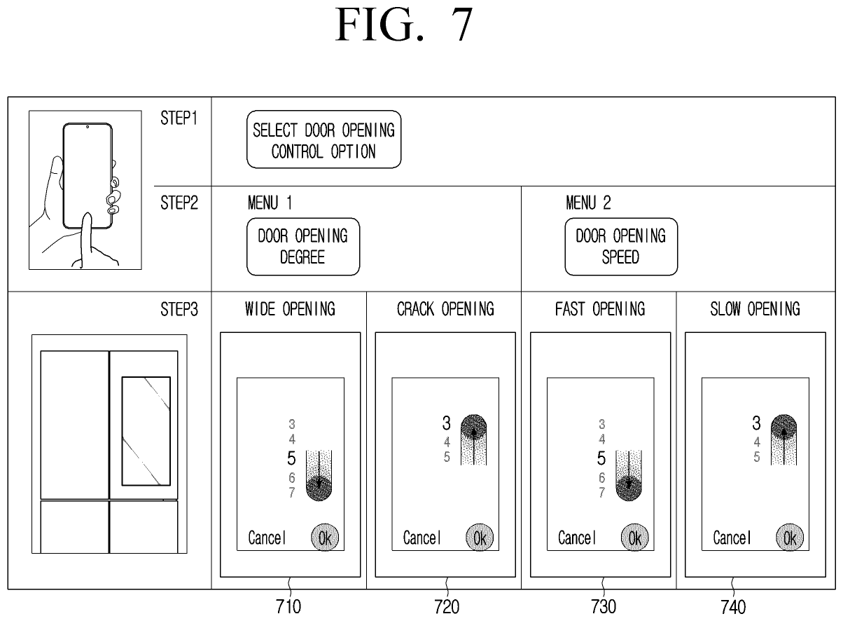

The user may confirm information about a door opening speed and/or a door opening angle displayed on the display 150 and may define the door opening speed and/or the door opening angle through the input device 140. A specific operation of setting the door opening speed and/or the door opening angle through a button is described with reference to FIG. 6. Further, in case that the input device 140 and the display 150 are configured as a touch screen, a specific operation of setting the door opening speed and/or the door opening angle is described with reference to FIG. 7.

Still further, the input device 140 may receive a user command for opening a door. For example, the input device 140 may be implemented as a microphone obtaining a voice command of the user, a switch turned on by contact of the user, a touch screen obtaining a touch input of the user, or a sensor detecting a gesture of the user but is not limited thereto.

The sensor 160 may obtain distance information about an object present around the refrigerator 100. The processor 120 may control each configuration of the refrigerator 100 based on the distance information (or size information) about the object obtained through the sensor 160. As an example, if the user is detected within a threshold distance (e.g. 30 cm) from the refrigerator 100 while the second door 30 is opened, the processor 120 may stop driving the motor 220 to stop opening the door.

Further, the processor 120 may determine whether to open the door based on the distance information about the object detected through the sensor 160. Specifically, the processor 120 may detect whether the object (e.g. an object in the user's hand) is present within a first distance (e.g. 10 cm) from a preset area R of the refrigerator 100. Here, the preset area R may be an area of an upper end of the door 30 of the refrigerating chamber. If the object is detected within the first distance, the processor 120 may identify whether the object is detected for a threshold time (e.g. two seconds) range. If the object is detected for the threshold time range, the processor 120 may determine that there is a need to open the door and generate a door opening event.

Meanwhile, it is described above that the door opening event is generated if the user is detected for a certain time at a certain distance (a first detection pattern) but upon implementing, the door opening event may be generated correspondingly to various detection patterns. This example is after-mentioned with reference to FIG. 9.

Further, the processor 120 may detect a size of the object detected through the sensor. Specifically, a division about whether the user is an adult or a child may be made based on the detected object. Further, the processor 120 may adjust the door opening speed or the door opening angle based on the confirmed size of the object. For example, if the preset door opening speed has a relatively fast value but the confirmed size of the object corresponds to a size of a child, the processor may control the door opening device 200 to open the door at a slow speed rather than the preset speed.

As above, the door opening speed according to the disclosure not only may be changed based on a value defined by the user but also may be variably applied in a real performing process. As previously described, it is possible to adjust the door opening speed or angle based on the detected size of the object. Otherwise, if the door opening event occurs in a voice recognition method, the processor may operate by analyzing a voice of the user and varying the door opening speed or angle as above based on an age of the analyzed voice.

Also, if the door opening speed or the door opening angle is directly inputted by the user, the processor 120 may perform an operation corresponding thereto. For example, if the user utters “Open the refrigerator door wide.”, the processor may receive the relevant voice signal through the microphone (not shown) and open the door at an angle corresponding to the received voice command.

Meanwhile, the uttered voice may be detected by a microphone of other devices rather than the microphone (not shown) included in the refrigerator 100. For example, an AI speaker, a TV, or a user terminal device connected to a home network may recognize the uttered voice and the refrigerator 100 may receive a control command based on a recognition result and perform the aforementioned operation.

Meanwhile, the basic configuration of the refrigerator 100 is described in FIGS. 4 and 5. However, the other configurations (e.g. a compressor, a microphone, or a speaker) may be further included besides the shown configuration, wherein the partial configuration shown in FIG. 5 may have an omitted shape.

FIG. 6 is a view illustrating an operation of a display according to an embodiment.

Specifically, FIG. 6 shows an example of a control panel 600 which may be included in the refrigerator.

The control panel 600 may include a plurality of panels and a plurality of screens and may display a current setting value of the refrigerator or receive a command for changing the setting value. Specifically, the control panel 600 may include a door opening control panel area 610 for receiving the door opening speed and/or door opening angle.

The door opening control panel area 610 may include a display area 611 displaying a setting value and an input area 613 receiving user manipulation. Meanwhile, in the shown embodiment, it is illustrated as an example that two setting values are received only with one area but upon implementing, the door opening speed and the door opening angle may be inputted by using different input areas.

The display area 611 includes an area where a type of information, which is currently being displayed is displayed and an area where a setting value of the relevant information is displayed.

The input area 613 may be implemented as a button, or the like and may receive first user manipulation or receive second user manipulation from the user. Here, the first user manipulation is a long press input in which the relevant button is selected for the preset time or more and the second user manipulation is a short press input in which the relevant button is selected for less than the preset time.

The user may define the door opening speed and the door opening angle by using the input area 613. Hereinafter, the detailed setting process is described.

An initial user may input a door opening angle/speed setting by selecting the input area 613. Correspondingly, the display area 611 may alternately display or alternately emit a setting value of information to be displayed to display the entrance into a setting stage.

Further, for example, the user may input less than the preset time into the input area 613 and sequentially change the relevant value while information of a current door opening angle is displayed to perform a required setting. The value increases in stages according to the number in which the user presses the button and after a maximum value 640, the value may be changed to a minimum value 650 again. The input area 613 may also include door opening speed where fast opening 660 and slow opening 670 is implemented.

If the user wants to correct the door opening speed after adjusting the door opening angle through the above process, the user may change a setting mode by pressing the input area 613 for the preset time or more. This setting mode may include a door opening angle setting mode and a door opening speed setting mode, wherein conversion may be made between two modes correspondingly to the first user manipulation.

If the mode is changed to the door opening speed by the first user manipulation, the user may change the door opening speed by selecting the input area 613.

Meanwhile, in the aforementioned setting process, if a preset time (e.g. 30 seconds) is elapsed when the user selects the button, the processor 120 may consider that the setting operation is completed and store the inputted setting value in the memory 110. Otherwise, the user may end the setting operation by pressing the input area 613 for a second preset time (e.g. 10 seconds).

Meanwhile, the preset time is an example and upon implementing, the value may be differently set.

As above, it is shown and described that all of the door opening speed and the door opening angle are defined by the user but upon implementing, the refrigerator 100 may be implemented such that the refrigerator fixes the door opening angle and receives only a setting of the door opening speed or fixes the door opening speed and receives only a setting of the door opening angle.

FIG. 7 is a view illustrating an operating of receiving a setting of a door opening speed or a door opening angle through a user interface window according to an embodiment.

Here, the user interface window may be a UI window displayed on a display of the refrigerator 100 and the setting may be displayed on a separate external device. For example, the separate external device may be a user terminal device (i.e. a smart phone).

The user interface window 710, 720, 730, 740 may display a current setting value or receive a command for changing the setting value. For example, the setting value may be changed correspondingly according to a touch direction of the user in the user interface window 710, 720 to which a door opening degree is inputted. The setting value may be changed correspondingly according to a touch direction of the user correspondingly even to the user interface window 730, 740 to which a door opening speed is inputted.

Further, the user may define an OK area displayed on a lower end of the user interface window to end the setting stage. As above, if the user interface window is displayed on the user terminal device, the input value defined by the user correspondingly to selection of the OK area may be transmitted to the refrigerator 100. Further, if the refrigerator 100 displays the user interface window, the input value defined by the user may be stored in the memory 110.

Meanwhile, it is illustrated in the shown example that the door opening angle value and the door opening speed value are individually defined but upon implementing, the door opening speed value may be somewhat limited by the door opening angle value. For example, if the door opening angle is small, it may be difficult to operate at a fast door opening speed. Also, if the door opening angle is large, it is difficult to open the door at a large angle based on a very slow door opening speed. Therefore, the door opening speed may be defined to rely on the door opening angle. For example, if the door opening angle value is defined as a value of 1 to 3, the door opening speed may be defined within a range of 1 to 4 and on the contrary, if the door opening angle value has a value of 6 to 7, the door opening speed may be defined within a range of 3 to 7. Also, to the contrary of the aforementioned process, the range capable of being inputted based on the door opening angle may be also changed to correspond to a preset speed.

FIG. 8 is a view illustrating a relation of a defined door opening speed and door opening angle, and an operation of a motor and a relation among operations of a protrusion member.

With reference to FIG. 8, is shown a relation among an opening angle (or an opening degree), a speed of a motor according to an opening speed, a motor rotation time, an exposure length, and an exposure speed. To facilitate the description of the shown embodiment, the description is made under the assumption of two cases, that is, a case that only the opening angle is changed and a case that only the opening speed is changed.

In advance, to increase the opening angle, a protrusion length of the protrusion member is to be increased. Therefore, as the opening angle increases, a driving time of the motor may be increased (b=b++). As above, it may be confirmed that as the motor rotation time increases, the protrusion length also increases (l=l++).

On the contrary, to decrease the opening angle, the protrusion length of the protrusion member is to be decreased. Therefore, as the opening angle decreases, a driving time of the motor may be decreased (b=b−−). As above, as the motor rotation time decreases, the protrusion length becomes shorter (l==l−−) and thus the opening angle is decreased. Further, the change of the value as above may proceed up to a minimum driving time. This is because, for example, if a driving time becomes very short as much as the door cannot be opened, it is not possible to open the door. Therefore, the motor opening time may be adjusted within a time range from a minimum time in which the door can be opened to a time in which the protrusion member maximally protrudes.

Further, to increase the opening speed, if a movement speed of the protrusion member is increased (s=s++), the door opening also becomes fast accordingly. Still further, in that the protrusion member moves in proportion to a rotation speed of the motor, the rotation speed of the motor may be increased (a=a++).

On the contrary, to decrease the opening speed, if a movement speed of the protrusion member is decreased (s=s−−), the door opening also becomes slow accordingly. Further, in that the protrusion member moves in proportion to a rotation speed of the motor, the rotation speed of the motor may be decreased (a=a−−).

Meanwhile, if the protrusion member maintains a current position after the door is opened as above, the user cannot close the door even though the user wants to close the door. This is because the protrusion member protrudes. Therefore, the refrigerator 100 may control the door opening device 200 such that the protrusion member is stored inside if a preset time is elapsed (or if the protrusion member moves up to its final protrusion position) after the protrusion member protrudes.

FIG. 9 is a view illustrating a door opening operation of a refrigerator according to an embodiment. Specifically, FIG. 9 is a view illustrating a scene that the refrigerator is viewed from the top.

With reference to FIG. 9, the refrigerator 100 may open the door 30 based on a distance d from the refrigerator 100 to the user. Specifically, the door 100 may detect the user by using the sensor 160. If the user is detected within a third distance d₃, the refrigerator 100 may enter into a mode for determining whether an event for opening the door occurs.

In this state, the user may move to within a first distance d₁, and the refrigerator 100 may determine whether to open the door based on whether the user is continuously detected within the relevant first distance.

Meanwhile, in this case, the user is disposed adjacent to the refrigerator 100 and thus the refrigerator 100 may output a message requesting that the user should move back because the door will be opened. Alternatively, if the user moves to between the second distance d₂ and the third distance d₃, the door opening may be determined.

Meanwhile, it is described above that the door is opened if the user is adjacent to the refrigerator and then moves back but upon implementing, the operation may be made in a different method.

For example, the sensor 160 may detect only an area of a lower end corresponding to the first distance di rather than a front direction of the refrigerator 100. In this case, if the user positions his/her legs within a first distance di for a certain time and the refrigerator detects an object for a certain time at the first distance di, the refrigerator may determine to open the door.

Here, the sensor 160 may determine whether to open the door based on the detected size of the object. For example, the sensor may identify if the object is an adult, a child, a pet, or the like based on the detected size of the object and may determine to open the door only if the object is an adult based on the identified object. Alternatively, if the object is identified as a child, the refrigerator may control the door opening device 200 such that the refrigerator door is opened on condition that the door is slowly opened.

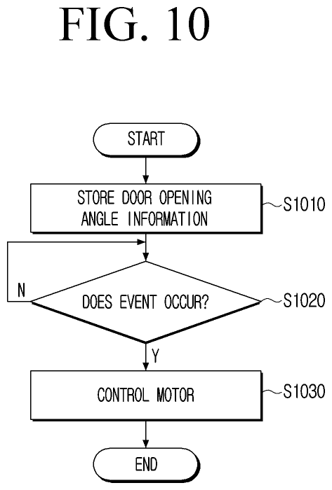

FIG. 10 is a flow chart illustrating a method of controlling a refrigerator according to an embodiment.

With reference to 10, first, the method includes storing door opening angle information of the door (S1010). Here, the method may also include storing door opening speed information. The door opening angle information as above may be inputted by a user through an input device or may be received through an external device. The stored angle information or speed information may be updated based on at least one information of the angle information or the speed information inputted or received from the user or the external device.

For example, if the input device and the display included in the refrigerator are used, defined angle information or speed information may be displayed, the angle information or speed information displayed on the display may be changed to speed information or angle information based on first user manipulation, and an attribute value of information displayed on the display may be changed based on second user manipulation. As above, it is assumed and described above that one button is used but if a plurality of buttons are included, a speed and an angle may be inputted by using different buttons in different forms.

Further, the method includes confirming whether an event that the door is opened occurs (S1020). Specifically, the confirming may include detecting an object within a preset area of the refrigerator and generating an event that the door is opened if the object is detected within the preset area. Otherwise, if the door opening command is inputted through a user voice command, the door opening event may be generated. Alternatively, if the door opening command is inputted through a door opening button or a user terminal device, the door opening event may be generated. Meanwhile, this event may merely have a meaning of opening the door simply but upon implementing, the relevant event may include information for specifying a door to be opened if a plurality of doors may be opened and may include a door opening attribute (e.g. an opening speed or opening information).

If the event occurs, the method includes controlling the motor such that the protrusion member protrudes toward a protrusion position corresponding to stored door opening angle information among a plurality of protrusion positions (S1030). Specifically, the method includes controlling the motor to rotate in a driving speed corresponding to the door opening speed among a plurality of driving speeds. Otherwise, the method includes determining a driving speed and a driving time corresponding to the stored door opening speed and stored door opening angle information and controlling the motor based the determined driving speed and driving time.

Meanwhile, the method includes, if the user designates an opening speed or an opening angle through a voice command, or the like, controlling the motor based on the opening speed or the opening angle corresponding to the voice command rather than the preset value.

Further, the method includes, if the door opening operation is completed or if the preset time is elapsed after the protrusion member protrudes due to occurrence of the event, controlling the motor such that the protrusion member moves to a storage position.

Through the method of controlling the refrigerator according to the disclosure as above, the door may be opened at various speeds or opening angles and thus the door may be opened in accordance with various needs of the user. The control method as above may be applied to the configurations of the refrigerator shown in FIGS. 1 to 5. Also, upon implementing, the control method may be applied to any case of including a rotatable door and including a door opening device for automatically opening the relevant door besides the refrigerator.

Meanwhile, various embodiments described as above may be implemented in a recording medium that may be read by a computer or a device similar thereto by using software, hardware, or a combination thereof. In some cases, embodiments described in the specification may be implemented as a processor itself. it According to software implementation, embodiments such as procedures and functions described in the specification may be implemented as separate software modules. Each of software modules may perform one or more functions and operations described in the specification.

Meanwhile, computer instructions for performing the processing operation according to the various embodiments of the disclosure may be stored in a non-transitory computer readable medium. Computer instructions stored in this non-transitory computer readable medium that, when executed by a processor, causes a specific device to perform a processing operation according to the various embodiments.

The non-transitory computer readable medium does not mean a medium that stores data for a short time such as a resistor, a cache, memory, or the like but means a machine readable medium that stores data semipermanently. A specific example of the non-transitory computer readable medium may be a CD, a DVD, a hard disk, a Blu-ray disk, a USB, a memory card, ROM, etc.

Meanwhile, a machine readable storage medium may be provided in a form of a non-transitory storage medium. Here, the term ‘non-transitory storage medium’ merely means that the storage medium is a tangible device and does not include a signal (e.g. an electromagnetic wave), wherein the term does not distinguish a case where data is stored semi-permanently in the storage medium and a case where data is stored temporarily therein. For example, the ‘non-transitory storage medium’ may include a buffer where data is temporarily stored.

According to an embodiment, a method according to various examples disclosed in the disclosure may be provided to be included in a computer program product. The computer program product may be traded between a seller and a buyer as goods. The computer program product may be distributed in a form of the machine-readable storage medium (e.g. compact disc read only memory (CD-ROM)) or may be distributed (e.g. downloaded or uploaded) on-line via an application store (e.g. play store™) or directly between two user devices (e.g. smart phones). In the case of the on-line distribution, at least part of the computer program product (e.g. a downloadable app) may be stored at least temporarily or may be generated temporarily in the machine-readable storage medium such as memory of a server of a manufacturer, a server of an application store, or a relay server. As the above, preferable examples of the present disclosure are shown and described. However, it is obvious that the disclosure is not limited to the aforementioned specific examples and various modifications may be implemented by those skilled in the art without deviating from the gist of the disclosure claimed in the scope of claims, wherein these modifications should not be independently understood from the technical spirit or prospect of the disclosure.

What is claimed is:

1. A refrigerator, comprising:
a main body having a storage chamber;
a door which is rotatable while coupled to the main body to open and close the storage chamber;
a door opening device, which includes a motor to drive a protrusion member, to open the door through a rotation of the motor;
a memory to store door opening angle information of the door; and
a processor to control the door opening device based on the stored door opening angle information upon an event in which the door be open occurs,
wherein the processor controls the door opening device to open the door by controlling the rotation of the motor to drive the protrusion member so that the protrusion member protrudes toward a protrusion position corresponding to the stored door opening angle information among a plurality of protrusion positions.

2. The refrigerator of claim 1, the memory is configured to:
store information about a door opening speed, and
wherein the processor is configured to:
control the motor to rotate in a driving speed corresponding to the door opening speed among a plurality of driving speeds.

3. The refrigerator of claim 2, wherein the processor is configured to:
determine a driving speed and a driving time corresponding to the stored information about the door opening speed and the stored door opening angle information and control the motor based on the determined driving speed and driving time.

4. The refrigerator of claim 1, further comprising:
an input device to receive a user manipulation command,
wherein the processor is configured to:
store at least one information of angle information or speed information inputted from the input device in the memory.

5. The refrigerator of claim 4, further comprising:
a display to display the stored at least one information of the angle information or the speed information,
wherein the processor is configured to:
change the at least one information of the angle information or the speed information which is being displayed on the display to speed information or angle information based on a first user manipulation which is a long press input for a preset time or more; and
change an attribute value of information which is being displayed on the display based on second user manipulation which is a short press input for less than a preset time.

6. The refrigerator of claim 1, further comprising:
a communication device to communicate with an external device,
wherein the processor is configured to:
store at least one information of angle information or speed information received from the communication device in the memory.

7. The refrigerator of claim 1, further comprising:
a sensor to detect an object within a preset area of the refrigerator,
wherein the processor is configured to:
based on the object being detected within the preset area, generate an event that the door is to open.

8. The refrigerator of claim 1, wherein the processor is configured to:
based on a preset time is elapsed after the protrusion member protrudes toward the protrusion position, control the motor to move the protrusion member to a storage position.

9. A method for controlling a refrigerator including a door and a door opening device, comprising:
storing door opening angle information of the door, the door opening device including a motor to drive a protrusion member;
confirming whether an event that the door be open occurs; and
based on the event occurring, controlling the door opening device to open the door by controlling a rotation of the motor such that the protrusion member protrudes toward a protrusion position corresponding to the stored door opening angle information among a plurality of protrusion positions.

10. The method of claim 9, wherein the storing includes storing information about a door opening speed, and
wherein the controlling includes:
controlling the motor to rotate in a driving speed corresponding to the door opening speed among a plurality of driving speeds.

11. The method of claim 10, wherein the controlling includes:
determining a driving speed and a driving time corresponding to the stored door opening speed and the stored door opening angle information and controlling the motor based on the determined driving speed and driving time.

12. The method of claim 9, further comprising:
receiving at least one information of angle information or speed information inputted through an input device; and
updating stored angle information or speed information based on at least one information of the inputted angle information or speed information.

13. The method of claim 12, wherein the receiving includes:
displaying the at least one information of the angle information or the speed information;
changing the at least one information of the angle information or the speed information which is on display to speed information or angle information based on a first user manipulation which is a long press input for a preset time or more; and
changing an attribute value of information which is on display based on a second user manipulation which is a short press input for less than the preset time,.

14. The method of claim 9, further comprising:
receiving at least one information of angle information or speed information from an external device; and
updating stored angle information or speed information based on the received at least one information of the angle information or speed information.

15. The method of claim 9, wherein the confirming includes:
detecting an object within a preset area of the refrigerator and based on the object being detected within the preset area, generating an event that the door be open.
